(19) United States
(12) Patent Application Publication
(10) Pub. No.: US 2017/0068186 A1
(43) Pub. Date: Mar. 9, 2017

(54) DEVELOPING APPARATUS, PROCESS CARTRIDGE, AND IMAGE FORMING APPARATUS

(71) Applicant: CANON KABUSHIKI KAISHA, Tokyo (JP)

(72) Inventors: Hiroki Tanaka, Ebina-shi (JP); Gosuke Goto, Kawasaki-shi (JP); Motonari Ito, Suntou-gun (JP)

(21) Appl. No.: 15/254,949

(22) Filed: Sep. 1, 2016

(30) Foreign Application Priority Data
Sep. 7, 2015 (JP) 2015-176063
Aug. 5, 2016 (JP) 2016-154526

(51) Int. Cl. G03G 15/08

(52) U.S. Cl. CPC G03G 15/0889

(57) ABSTRACT

A developing apparatus in which a developer bearing member rotates in a first rotational direction, a stirring member rotates in a second rotational direction opposite to the first rotational direction, and, in a contact region where the stirring member and the development bearing member contact each other, a moving speed of the developer bearing member is higher than a moving speed of the stirring member.

### BACKGROUND OF THE INVENTION

### Field of the Invention

Aspects of the present invention relate to a developing apparatus, a process cartridge, and an image forming apparatus.

A process cartridge includes at least an image bearing member. In many cases, a charging unit, a developing unit, a cleaning unit, and an image bearing member are integrally formed as a cartridge, which is detachably attached to the main body of an image forming apparatus.

A developing apparatus includes at least a developer bearing member. In many cases, a developer bearing member, a development frame for supporting the developer bearing member, and related parts are integrally formed as a developing apparatus, which is detachably attached to the main body of the image forming apparatus.

### Description of the Related Art

Electrophotographic image forming apparatuses such as laser beam printers and copying machines use toner as a powdery developer. Toner is stored in a developer container, conveyed to a toner bearing member by a toner conveyance unit such as a stirring sheet, and retained on the toner bearing member. When a predetermined electric charge is applied to toner by a developing blade serving as a toner layer thickness regulating member, toner moves onto an electrostatic latent image forming portion on the image bearing member to visualize the electrostatic latent image on a photosensitive member as an image bearing member. Then, this visible image is transferred onto a transfer material such as paper by a transfer unit and then fixed thereto by a fixing apparatus. The toner remaining on the image bearing member without being transferred to the transfer material is peeled off from the surface of the image bearing member by a cleaning apparatus which is in contact with the image bearing member, and is sent to a cleaning container. When a series of these image forming processes is completed, a user is able to obtain a desired image.

As one of development methods, the jumping development method is known to develop a latent image on an image bearing member while holding a developer bearing member of an image forming apparatus which is not in contact with the image bearing member. An example of a developing apparatus employing the jumping development method is described below.

In the developing apparatus employing the jumping development method, toner stored in a developer container is conveyed by a stirring sheet, etc. and is retained on a developing sleeve as a developer bearing member. When the developing sleeve rotates, toner as a mono-component developer held on the developing sleeve is conveyed toward a developing region facing a photosensitive member serving as an image bearing member. During conveyance, toner is regulated by a blade in contact with the developing sleeve and is applied onto the developing sleeve to be a thin layer. In the developing region, the developing sleeve and the photosensitive member are held with a 50 to 500-μm gap formed therebetween. Then, a developing bias of a direct current with an alternate current superimposed thereon is applied to the developing sleeve. The toner applied to the developing sleeve in a thin layer state, flies and adheres to an electrostatic latent image on the photosensitive member, and the latent image is visualized as a toner image.

As a method for prolonging the life time (use period) of such a developing apparatus, there is known a method for rotating a stirring sheet as a stirring member in the same direction as the rotational direction of a developer bearing member and bringing the stirring sheet into contact with the developer bearing member (Japanese Patent Application Laid-Open No. 2001-117369). The configuration of this developing apparatus is illustrated in FIG. 7. By bringing the stirring sheet as a stirring member into contact with the developer bearing member, the entrainment of toner to the developing sleeve, and the deposition of foreign substances such as paper powder and other fine powder on the developer bearing member are hindered. This reduces the deposition of sticking substances on the surface of the developing sleeve. There is disclosed a technique for prolonging the life time of a developing apparatus by extending the period until an image is affected by sticking substances.

However, a configuration discussed in Japanese Patent Application Laid-Open No. 2001-117369 cannot sufficiently reduce sticking substances on the developer bearing member. For example, in a certain case, a region where toner is peeled off from the developer bearing member overlaps with a region to which the toner on the developer bearing member is conveyed. In this case, since the toner becomes dense (a region C surrounded by a dotted line illustrated in FIG. 7), the adhesion of sticking substances such as the entrainment of toner cannot be sufficiently reduced, making the extension of the life time (use period) of the developing apparatus difficult to achieve.

### SUMMARY OF THE INVENTION

According to an aspect of the present invention, a developing apparatus includes, a developer bearing member configured to bear a developer and rotate to apply the developer to an image bearing member to perform image forming; and a stirring member configured to stir a developer, having (1) a rotating rotary member and (2) a flexible sheet member attached to the rotary member a free end of the sheet member being capable of contacting a surface of the developer bearing member in an image forming region. The developer bearing member rotates in a first rotational direction. The stirring member rotates in a second rotational direction which is opposite to the first rotational direction. In a contact region where the stirring member and the development bearing member contact each other, a moving speed of the developer bearing member is higher than a moving speed of the stirring member.

According to another aspect of the present invention, a developing apparatus includes, a developer bearing member configured to bear a developer, rotate to apply the developer to an image bearing member to perform image forming, and, after an image formed on the image bearing member is transferred onto a recording medium, collect a developer remaining on the image bearing member; and a stirring member configured to rotate to stir the developer and, when rotating, contact a surface of the developer bearing member in an image forming region. The developer bearing member rotates in a first rotational direction. The stirring member rotates in a second rotational direction which is opposite to the first rotational direction. In a contact region where the stirring member and the development bearing member contact each other, a moving speed of the developer bearing member is higher than a moving speed of the stirring member.

Aspects of the present invention offer a process cartridge and an image forming apparatus.

Further features of the present invention will become apparent from the following description of exemplary embodiments with reference to the attached drawings.

### BRIEF DESCRIPTION OF THE DRAWINGS

FIG. 1 is a sectional view schematically illustrating a developing apparatus according to a first exemplary embodiment of the present invention.

FIG. 2 is a schematic view illustrating a positional relation between a developing sleeve and a stirring member when viewed from a direction X illustrated in FIG. 1.

FIG. 3 is a sectional view schematically illustrating an image forming apparatus according to the first exemplary embodiment of the present invention.

FIGS. 4A and 4B schematically illustrate a motion in which the developing sleeve and a stirring sheet according to the first exemplary embodiment rotate in the same direction when viewed from a contact portion.

FIG. 5 schematically illustrates a drive configuration of the developing sleeve and the stirring member according to the first exemplary embodiment.

FIG. 6 is a sectional view schematically illustrating an image forming apparatus using a cleanerless system according to a second exemplary embodiment.

FIG. 7 schematically illustrates, as a conventional example, a motion of the stirring sheet in the direction opposite to the motion of the developing sleeve.

### DESCRIPTION OF THE EMBODIMENTS

An image forming apparatus according to a first exemplary embodiment of the present invention will be described below with reference to the accompanying drawings. The following exemplary embodiments are shown to describe the present invention. Sizes, materials, shapes, and relative arrangements of elements described in the exemplary embodiments are not limited thereto unless otherwise specifically described.

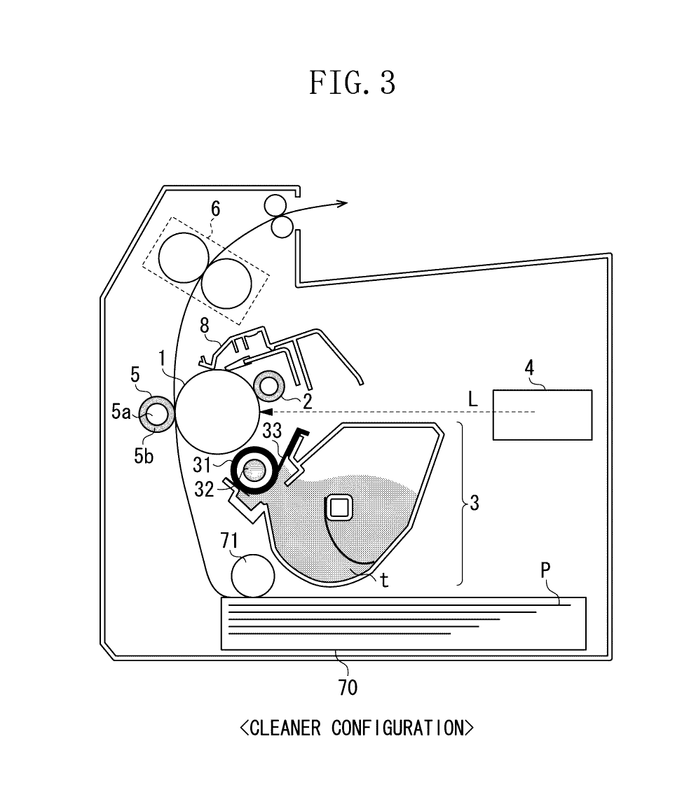

An image forming process and a configuration of the image forming apparatus will be described below with reference to FIG. 3.

FIG. 3 schematically illustrates the image forming apparatus according to an aspect the present invention. This image forming apparatus is a monochrome laser beam printer which employs the electrophotographic process.

### <Image Forming Process>

When a print signal is input to a controller in the main body of the image forming apparatus, the image forming apparatus starts an image forming operation. Each drive unit starts operating at a predetermined timing, and a voltage is applied.

A photosensitive drum 1 as a rotatably driven image bearing member is uniformly charged by a charging roller 2 as a charging member. The uniformly charged photosensitive drum 1 is exposed to laser light L emitted from a scanner unit 4 serving as an exposure unit, and an electrostatic latent image (or an electrostatic image) is formed on the surface of the photosensitive drum 1. Subsequently, a developer is supplied to the electrostatic latent image from a developing sleeve 31 as a developer bearing member, and the electrostatic latent image is visualized as a developer image.

On the other hand, a recording medium P is separated and fed from a recording medium housing unit 70 by a recording medium supply unit 71. In synchronization with a timing of forming a developer image on the photosensitive drum 1, the recording medium supply unit 71 sends out the recording medium P to a portion (transfer portion) where a transfer roller 5 as a transfer unit faces the photosensitive drum 1.

The developer image visualized on the photosensitive drum 1 in this way is transferred onto the recording medium P by the transfer roller 5. The recording medium P with the developer image transferred thereon is conveyed to a fixing unit 6. An unfixed toner image on the recording medium P is heated and pressed to be fixed on the recording medium P. Subsequently, the recording medium P is discharged to the outside of the main body of the image forming apparatus by a discharge roller. Meanwhile, a residual developer remaining on the photosensitive drum 1 after transferring the developer image is removed by a cleaning apparatus 8. Then, the following image forming process is performed.

### <Descriptions of Developing Apparatus>

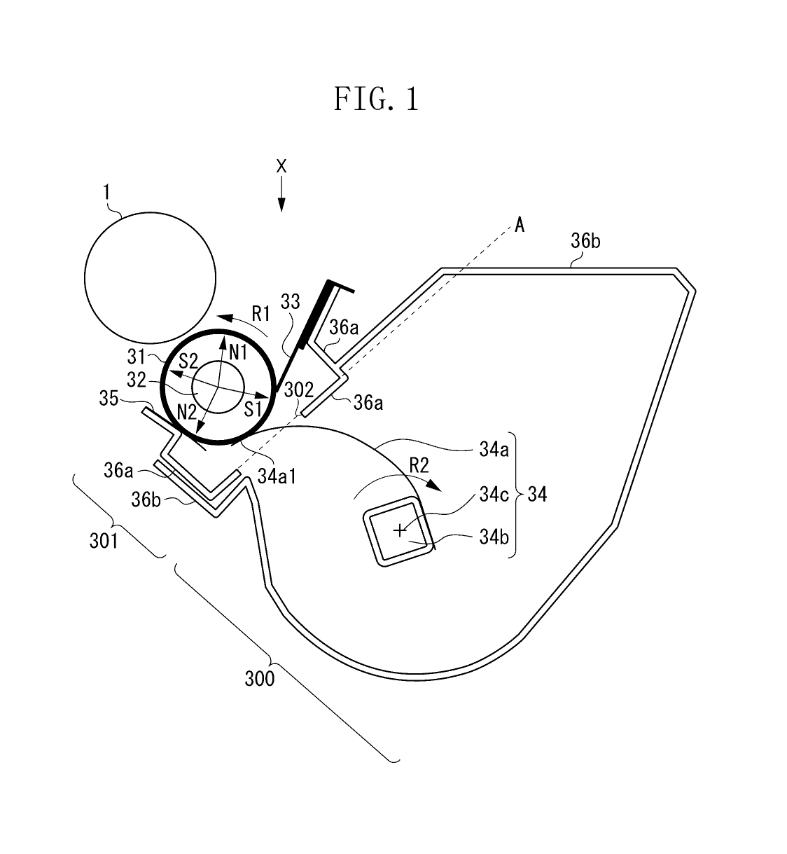

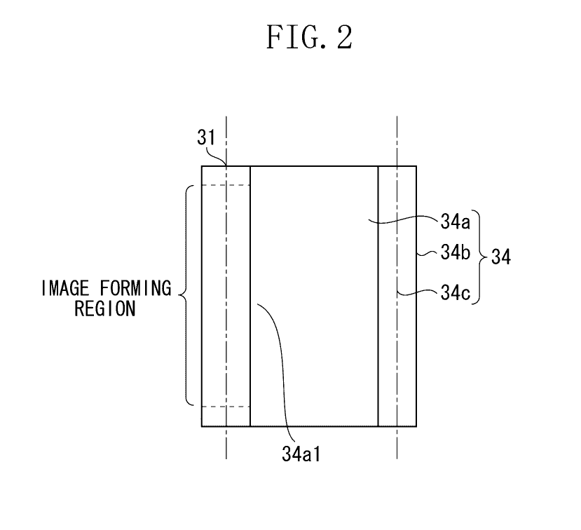

The present exemplary embodiment employs the non-contact developing method (jumping development method) and uses a configuration of a developing apparatus 3 illustrated in FIG. 3. Detailed configuration is illustrated in FIGS. 1 and 2. The developing apparatus 3 according to the present exemplary embodiment is detachably attached to the main body of the image forming apparatus.

FIG. 1 illustrates the position of the developing apparatus 3 when attached to the main body of the image forming apparatus (the position of the developing apparatus 3 when in use). FIG. 2 illustrates a positional relation between the developing sleeve 31 and a stirring member when viewed from the direction X illustrated in FIG. 1. More specifically, FIG. 2 illustrates a contact state where a free end 34a1 of a stirring member 34a (described below) contacts the circumferential surface of the developing sleeve 31. The vertical direction illustrated in FIG. 2 is the longitudinal direction of the developing sleeve 31.

As illustrated in FIG. 1, at the attachment position, the lowermost portion of the developer bearing member is located above the bottom portion of a developer containing chamber (toner container 300) for storing developer. Conversely, the bottom portion of the developer containing chamber is located below the lowermost portion of the developer bearing member. This configuration is a so-called pumping configuration.

Although, in the present exemplary embodiment, magnetic toner (magnetic developer) is used, the developer is not limited thereto. A two-component developer composed of a carrier and toner or a non-magnetic developer may be used depending on the configuration.

The developing apparatus includes a developer container 301 (developing chamber) and a toner container 300 (developer containing chamber) for storing toner. The developer container 301 includes the developing sleeve 31 as a developer bearing member, and a developing blade 33 as a layer thickness regulating member for regulating the thickness of the developer layer. The toner container 300 includes a stirring member 34. The developer container 301 communicates with the toner container 300 through a development opening A (opening 302). The developer container 301 and the toner container 300 are composed of a first frame 36a and a second frame 36b, respectively. The first frame 36a has a development opening A.

The developing sleeve 31 is non-magnetic and composed of a pipe coated with a paint containing dispersed carbon. The pipe is made of aluminum or stainless steel.

The paint coat on the surface of the developing sleeve 31 provides coarseness which contributes to the toner conveyance characteristics of the developing sleeve 31. Further, the developing sleeve 31 is rotatably supported by a bearing (not illustrated), and is rotating in an R1 direction illustrated in FIG. 1 via a gear driven by the photosensitive member 1. The developing sleeve 31 is connected to a power supply that can superimpose an alternate current (AC) bias onto a direct current (DC) bias. The latent image on the photosensitive drum 1 is visualized as a toner image by applying bias from the power supply. Further, the developing sleeve 31 is supported at predetermined development intervals opposing the photosensitive drum 1. The developing blade 33, as a toner layer thickness (amount of toner application) regulating member on the developing sleeve 31, gives suitable triboelectricity to toner through triboelectric charging. The developing blade 33 is a blade made of urethane rubber. The thickness of the toner layer on the developing sleeve is set to be thinner than the above-described minimum gap between the photosensitive drum 1 and the developing sleeve 31. Toner is negative toner as a magnetic mono-component system developer (mono-component developer).

With respect to the developing sleeve 31, a magnet roller 32 includes a magnetic body which is fixedly disposed. The magnet roller 32 has magnetic poles in four directions as illustrated in FIG. 1. The S2 pole of the four magnetic poles is required to make toner (cause of fogging) adhere to the developing sleeve 31 when toner flies onto the photosensitive drum 1 and is developed. The S1 pole disposed at the side opposite to the S2 pole causes the toner in the developer container 301 to stick to the developing sleeve 31. Both the N1 and the N2 poles help the conveyance of the toner coating the developing sleeve 31 and the application of triboelectricity. Although, in the present exemplary embodiment, a 4-pole magnet roller is used for the magnet roller 32, the magnet roller 32 is not limited to a four-pole magnet roller as long as there is a pole that achieves the above-described function.

Thus, in the present exemplary embodiment, the developer bearing member (developing sleeve 31) is configured to bear the developer and, by rotating, cause the developer to adhere to the image bearing member to form an image (developer image).

At a lower portion of the developing sleeve 31 inside the developer container 301, a toner blowoff prevention sheet 35 is provided to prevent toner leak from the lower portion of the developing sleeve 31.

The stirring member 34 is composed of a stirring axis portion 34b as a rotary member and the stirring sheet 34a as a flexible sheet member fixed to the stirring axis portion 34b. More specifically, one side of the stirring sheet 34a is attached to the stirring axis portion 34b and the other side thereof serves as the free end 34a1. The center of the stirring axis portion 34b is a stirring center 34c which serves as the axis line of the stirring axis portion 34b.

The stirring sheet 34a contacts the bottom portion of the toner container 300 making inroad into the toner container to loosen the toner contained in the toner container 300. Further, when the stirring sheet 34a rotates to rub the bottom portion of the toner container 300, it conveys toner from the toner container 300 to the developer container 301.

The stirring sheet 34a having conveyed toner rotates in an R2 direction illustrated in FIG. 1 to contact the developing sleeve 31.

After contact, the stirring sheet 34a further rotates to bring a part of toner in the developing chamber (developer container 301) back to the toner chamber (toner container 300) and activates the toner circulation in the toner chamber (toner container 300) and the developing chamber (developer container 301).

Thus, the stirring member 34 rotates to stir the developer. The stirring member 34a is configured to, when rotating, contact the surface (circumferential surface) in the image forming region (illustrated in FIG. 2) in the developer bearing member (developing sleeve 31). The image forming region in the developer bearing member is a region on the developer bearing member corresponding to the region of an electrostatic latent image formed on the image bearing member.

When the stirring member 34 is not rotating, except for a specific stop position, the stirring sheet 34a may not contact the surface of the developer bearing member (developing sleeve 31). When the stirring member 34 starts rotating, the stirring sheet 34a can contact the surface of the developing sleeve 31.

The stirring member 34 is disposed within the developer containing chamber (toner container 300) and the stirring sheet 34a is long enough to contact the bottom portion of the developer containing chamber (toner container 300). Thus, the stirring member 34a can easily stir the developer near the bottom portion of the developer containing chamber (toner container 300).

### <Toner Fusion>

The toner charge amount and the thickness of the toner layer on the developing sleeve 31 depend on the surface state of the developing sleeve 301. Therefore, to maintain a homogeneous image quality through the life time of the cartridge, it is necessary to reduce a change in the surface state of the developing sleeve 301 through the life time of the cartridge. The toner fusion is an example of a change in the surface state of the developing sleeve 301, and is a factor for determining the life time of the cartridge. A toner fusion forming process on the developing sleeve 301 will be described below.

When the cartridge is used under severe conditions, for example, in a case where printing of excessive number of sheets is performed a day or in a case where continuous printing is excessively performed, the toner temperature rises together with the temperature in the cartridge. In particular, under a high-temperature and high-humidity environment, when the toner temperature rises to the vicinity of the glass transition point, toner becomes soft and easy to deteriorate. In this situation, if printing in a small amount of toner consumption, i.e., printing with a low printing rate is repeated in this state, the toner circulation on the developing sleeve 301 does not actively take place, and toner is repetitively regulated by the developing blade 33. Thus, the toner fusion occurs, i.e., toner adheres to the surface of the developing sleeve 31.

When toner fuses and adheres to the developing sleeve 31, the reduction in triboelectricity due to a change in the surface state of the developing sleeve 31, and a fluctuation (change) of the toner conveyance amount on the developing sleeve 31 due to a coarseness change on the surface of the developing sleeve 31 occur, which makes it difficult to form a suitable image and it becomes necessary to replace the cartridge. In such a state, it is difficult to sufficiently prolong the use period of the cartridge.

### <Contact Configuration Between Stirring Sheet and Developing Sleeve>

A contact configuration between the stirring sheet 34a and the developing sleeve 31 will be described below.

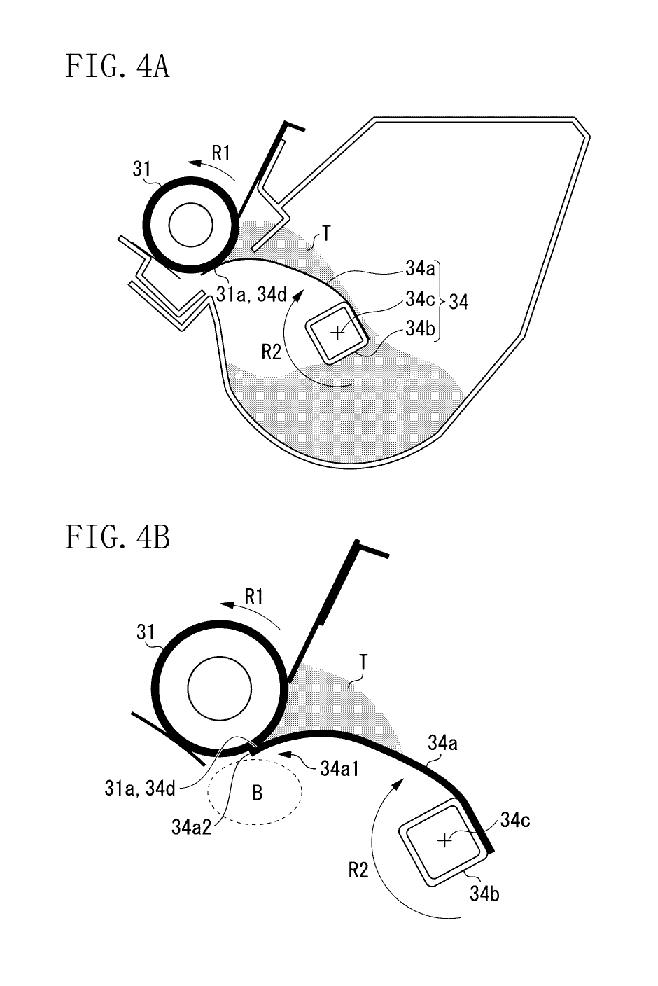

In the present exemplary embodiment, to effectively peel off the toner on the developing sleeve 31, the surfaces of the stirring sheet 34a and the developing sleeve 31 contact each other while rotating in the forward direction, as illustrated in FIGS. 4A and 4B. Further, the circumferential speed (moving speed) of the developing sleeve 31 is higher than the circumferential speed (moving speed) of the stirring sheet 34a.

More specifically, the developer bearing member (developing sleeve 31) rotates in a first rotational direction (R1), and the stirring member 34 rotates in a second rotational direction (R2) which is opposite to the first rotational direction. Further, in a contact region where the stirring member 34a and the developer bearing member contact each other, the moving speed (linear velocity) of a contact portion 31a of the developer bearing member is set to be higher than the moving speed (linear velocity) of a contact portion 34d of the stirring member 34a.

### (1) Rotational Direction of Stirring Sheet and Developing Sleeve

With the above configuration, the toner on the developing sleeve 31 is scraped each time the stirring sheet 34a contacts the developing sleeve 31. In particular, as illustrated in FIG. 2, when the longitudinal length of the free end of the stirring sheet 34a is longer than a toner coating region (image forming region) of the developing sleeve 31, it becomes possible to bring the stirring sheet 34 into a contact with the entire toner coating region on the developing sleeve 31. Therefore, the toner on the developing sleeve 31 is effectively peeled off over the entire longitudinal region. Thus, the toner on the developing sleeve 31 is not repetitively regulated by the developing blade 33 over the entire longitudinal region, which reduces the possibility that the toner fusion occurs on the surface of the developing sleeve 31.

In the present exemplary embodiment, the surface of the stirring sheet 34a contacts the surface of the developing sleeve 31, and the tip of the stirring sheet 34a also contacts the surface of the developing sleeve 31 (refer to FIG. 2). In the contact region, the contact portions 31a and 34d contact each other and move in the same direction. The contact portions 31a and 34d are generated when they contact each other, and exist both on the stirring sheet 34a and the developing sleeve 31. (2) Speed of stirring sheet and developing sleeve

The developing sleeve 31 employed by the present exemplary embodiment has an outer diameter of φ11 mm, and is rotating in the R1 direction indicated by the arrow R1 (first rotational direction). The distance between the rotation center of the developing sleeve 31 and the rotation center of the stirring sheet 34a is 31 mm. The tip portion of the stirring sheet 34a is rotating in the R2 direction (second rotational direction) with a radius of 26 mm centering on the stirring axis portion 34b. As understood from FIG. 1, the first rotational direction and the second rotational direction are opposite to each other. In this configuration, in a case where the stirring sheet 34a does not bend, the developing sleeve 31 and the stirring sheet 34a contact each other with an inroad amount of 5 mm.

In this case, the circumferential speed of the developing sleeve 31 is higher than the speed of the stirring sheet 34a (speed of the stirring member 34). The developing sleeve 31 passes the stirring sheet 34a with a relative speed of 175 mm/second. In this case, the circumferential speed of the developing sleeve 31 is about 232 mm/second and the speed of the stirring member 34a is about 57 mm/second. The speed of the stirring member 34a is the moving speed of a circle drawn by the free end (tip portion) of the stirring sheet 34a (assuming that there is no obstacle). By rotating the stirring sheet 34a with the above-described settings, the tip portion of the stirring sheet 34a can scrape the about 4-mm toner on the circumferential surface of the developing sleeve 31 during one contact. By rotating the stirring sheet 34a about 10 times, the toner can be scraped on the entire developing sleeve 31.

In the present exemplary embodiment, by rotating the developer bearing member (developing sleeve 31) in the first rotational direction (R1) and rotating the stirring member 34 in the second rotational direction (R2) which is opposite to the first rotational direction, the contact portions 31a and 34d of the developer bearing member and the stirring member 34, respectively, move in the same direction when the stirring member 34a and the development bearing member contact each other. Further, the moving speed of the contact portion 31a of the developer bearing member becomes higher than the moving speed of the contact portion 34d of the stirring member 34a.

The effect of peeling off of toner while the stirring sheet 34a contacts the developing sleeve 31 is determined by a state of the nip between the stirring sheet 34a and the developing sleeve 31, and the toner density in a region where the toner on the surface of the developing sleeve 31 is peeled off. Toner can be effectively peeled off when the stirring sheet 34a contacts the developing sleeve 31 in the forward direction. Details will be described below.

The contact portions 31a and 34d of the stirring sheet 34a and the developing sleeve 31, respectively, are illustrated in FIG. 4A. The flexible stirring sheet 34a contacts, in a bent state as illustrated in FIG. 4A, the surface of the developing sleeve 31. Immediately after the contact, the edge portion of the stirring sheet 34a does not contact the surface of the developing sleeve 31 as illustrated in FIG. 4A. In this state, since the nip portion formed between the stirring sheet 34a and the developing sleeve 31 increases in width and the pressure is dispersed, the effect of peeling off the toner on the surface of the developing sleeve 31 is small although the effect is maintained to a certain extent.

Subsequently, as illustrated in FIG. 4B, the contact state between the developing sleeve 31 and the stirring sheet 34a is an edge contact state in which the edge portion of the stirring sheet 34a contacts the surface of the developing sleeve 31. This state, because of a narrow nip portion which produces a high peak pressure, has a greater effect in peeling off the toner on the surface of the developing sleeve 31 than the state illustrated in FIG. 4A. Further, since it is immediately after the stirring sheet 34a supplies toner to the developing sleeve 31, a lower region in the gravitational direction relative to the nip portion (the B region drawn by a dotted line) in which the toner on the surface of the developing sleeve 31 is peeled off, shows a sparse toner state. Therefore, toner which is peeled off can be moved to the B region illustrated in FIG. 4B. More specifically, the above-described nip state and the lower region in the gravitational direction which has a sparse toner density, provide a great effect of peeling off toner. After a certain time has elapsed, the edge contact state is released and the stirring sheet 34a separates from the developing sleeve 31. As a result, the toner on the developing sleeve 31 is effectively peeled off each time the developing sleeve 31 and the stirring sheet 34a contact each other. Therefore, the toner on the developing sleeve 31 is not repetitively regulated by the developing blade 33, reducing the possibility of the toner fusion on the surface of the developing sleeve 31.

As understood from FIG. 4B, when the stirring member 34a and the developing sleeve 31 (developer bearing member) contact each other, the stirring sheet 34a (sheet member) bends and deforms so that an end surface 34a2 at the free end 34a1 of the stirring sheet 34a is oriented in the direction opposite to the moving direction of the developing sleeve 31 in the contact region. This brings about a favorable contact state between the edge portion (end surface 34a2) of the stirring sheet 34a and the surface (circumferential surface) of the developing sleeve 41, making it possible to more effectively peel off sticking substances.

Although, in the present exemplary embodiment, the ratio of the moving speed of the developing sleeve 31 (about 232 mm/second) to the moving speed of the stirring member 34a (about 57 mm/second) is about 4, the ratio is not limited thereto. It is desirable that this ratio is 2 to 8. However, the ratio can be 10 or less. In the configuration according to the present exemplary embodiment, if the ratio is larger than 10, sufficient toner may not be supplied to the developing sleeve 31. However, depending on the configuration, the ratio may be larger than 10.

In the present exemplary embodiment, since the stirring sheet 34a is bent under the weight of toner, the stirring sheet 34a and the developing sleeve 31 do not contact each other in the early stage of the development life. However, in the second half of the development life in which the weight of toner decreases, the above-described contact takes place. As a result of this, the developing sleeve 31 and the stirring sheet 34a effectively contact each other in the second half of the life time (the second half of the use period) in which the toner fusion tends to occur. Further, it becomes possible to prevent degradation of the surface of the developing sleeve 31 in comparison with a case where they contact each other from the early stage of the life time, so that more suitable configuration can be achieved. From another point of view, it can be thought that, the stirring sheet 34a does not contact the developing sleeve 31 when the amount of developer is equal to or greater than a predetermined amount and that the stirring sheet 34a contacts the developing sleeve 31 when the amount of developer is smaller than the predetermined amount.

Although the stirring sheet 34a employed in the present exemplary embodiment is made of polycarbonate having a thickness of 178 μm, the material of the stirring sheet 34a is not limited thereto. The stirring sheet 34a may be made of plastic such as polyethylene telephthalate (PET), and a copolymerization synthetic resin of acrylonitrile, butadiene, and styrene (ABS). The thickness may be designed taking the peeling off effect into consideration.

Similarly, the diameter of the developing sleeve 31, the length of the stirring sheet 34a, and the speed of each member are not limited to those according to the present exemplary embodiment.

The driving source for driving the developer bearing member and the stirring member 34 may be a shared driving source (for example, a motor) or separate driving sources (for example, a plurality of motors) provided in the image forming apparatus.

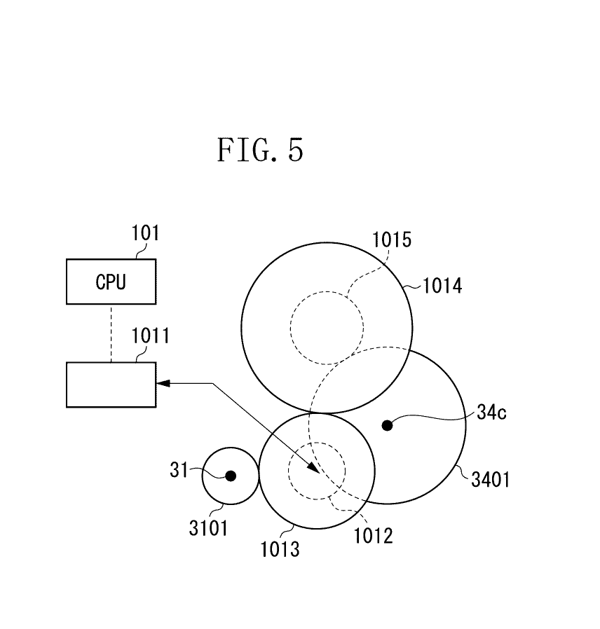

When the developer bearing member and the stirring member 34 are driven by separate driving sources, the speed of each member can be independently controlled by the control unit 101 (as illustrated in FIG. 5).

On the other hand, when the developer bearing member and the stirring member 34 are driven by the shared driving source, the diameters of respective gears for transmitting a driving force to the developer bearing member and the stirring member 34a are differentiated so that a predetermined circumferential speed difference can be obtained in the contact regions of the stirring member 34a and the developer bearing member (moving speed difference in the contact portions).

FIG. 5 is a schematic view illustrating a drive configuration for driving the developing sleeve 31 and the stirring member 34 according to the present exemplary embodiment.

As illustrated in FIG. 5, the developing apparatus according to the present exemplary embodiment includes an engaging member 1012 configuring a driving force receiving portion for receiving a driving force from a driving force output unit 1011 by engaging with the driving force output unit 1011 of the main body of the image forming apparatus.

The developing apparatus further includes a driving force transfer portion (gear portions 1013, 1014, and 1015) for transmitting the driving force which the driving force receiving portion (engaging member 1012)receives from the main body of the image forming apparatus, to the developer bearing member 31 and the stirring member 34.

In the present exemplary embodiment, the gear portion 1013 and the engaging member 1012 are integrally formed as one unit and are able to coaxially rotate. Further, the gear portion 1014 and the gear portion 1015 are also integrally formed as one unit and are able to coaxially rotate.

The gear portion 1013 engages with a gear portion 3101 coaxially disposed on the rotational axis of the developing sleeve 31. The gear portion 1013 is able to transmit the driving force from the main body of the image forming apparatus to the developing sleeve 31.

A gear portion 3401 coaxially disposed with the axis 34C of the stirring member 34 engages with the gear portion 1014. On the other hand, the gear portion 1013 engages with the gear portion 1015. Therefore, the driving force from the main body of the image forming apparatus can be transmitted to the stirring member 34 via the gear portions 1013, 1014, and 1015.

Thus, when the developing apparatus is attached to the main body of the image forming apparatus, the driving force receiving portion (engaging member 1012) engages with the drive output unit 1011 of the main body of the image forming apparatus, the driving force transfer portion (the gear portions 1013 to 1015) can transmit the driving force from the main body of the image forming apparatus to the developing apparatus.

In the present exemplary embodiment, the driving force output unit 1011 disposed in the main body of the image forming apparatus is driven by motors (not illustrated) controlled by the control unit 101 of the main body of the image forming apparatus.

### COMPARATIVE EXAMPLE

As a comparative example of the present exemplary embodiment, the following describes peeling off of the toner on the developing sleeve 31 in a case where the stirring sheet 34a contacts the developing sleeve 31 in the direction opposite to the travelling direction of the developing sleeve 31. The developing sleeve 31, the stirring sheet 34a, the distance between rotation centers, and the moving speeds are the same as those according to the present exemplary embodiment. In this case, similar to the contact in the forward direction, the developing sleeve contacts the tip of the stirring sheet 34a once at intervals of 1.43 seconds. During the contact, the stirring sheet 34a collides with the developing sleeve 31 at a relative speed of 288.62 mm/second and contacts the 6.1-mm toner on the circumferential surface of the developing sleeve 31. Each time the stirring sheet 34a rotates 5.84 times, the toner on the entire developing sleeve 31 can be scraped.

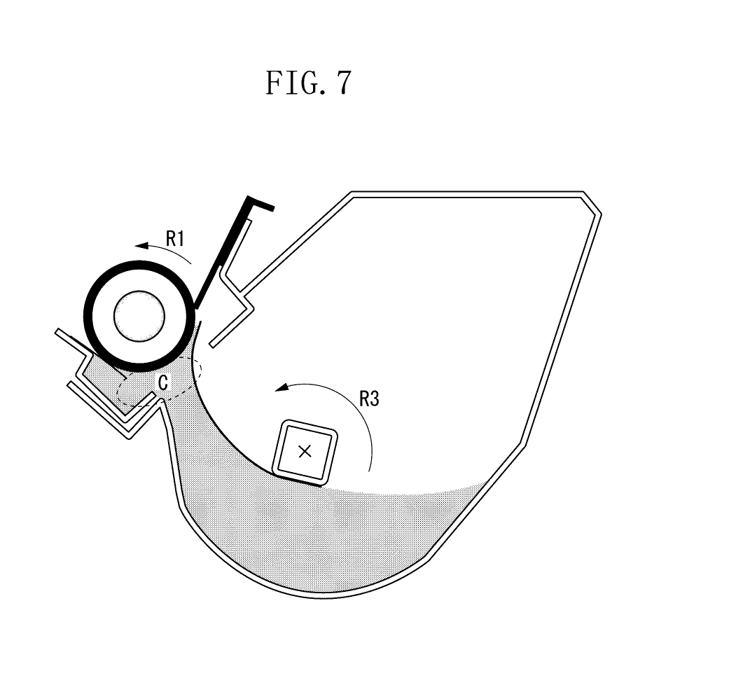

FIG. 7 illustrates a state immediately after the stirring sheet 34a contacts the developing sleeve 31 in the direction opposite to the moving direction of the developing sleeve 31. As illustrated in FIG. 7, in a state where the tip portion of the stirring sheet 34a is not in contact with the surface of the developing sleeve 31, the effect of peeling off the toner on the surface of the developing sleeve 31 is small because of a wide nip portion and hence a dispersed pressure. Further, the toner in the lower part in the gravitational direction is denser than the nip portion where the toner on the surface of the developing sleeve 31 is peeled off. Since it becomes difficult for the toner peeled off from the surface of the developing sleeve 31 to separate from the vicinity of the surface of the developing sleeve 31, the toner once peeled off is also attracted by the developing sleeve 31 through magnetism. As a result, in a case where the stirring sheet 34a rotates in the direction opposite to the moving direction of the developing sleeve 31 and contacts the developing sleeve 31, the toner on the developing sleeve 31 cannot be effectively peeled off. Accordingly, since toner is repetitively regulated by the developing blade 33, the toner fusion occurs on the surface of the developing sleeve 31.

A second exemplary embodiment employs a cleanerless system and differs from the first exemplary embodiment in that the contact developing method performed in a state that the image bearing member and the development bearing member is in contact with each other is not employed, and that the cleaning apparatus 8 is not provided.

### <Cleanerless System>

A cleanerless system refers to a configuration in which a developer image formed on an image bearing member such as a photosensitive drum is transferred onto a recording medium and then developer remaining on the image bearing member is collected by a developer bearing member. A cleanerless system does not include a configuration in which a cleaning apparatus is provided and the surface of the image bearing member is cleaned after transferring the developer before the surface of the image bearing member reaches the position facing the developer bearing member.

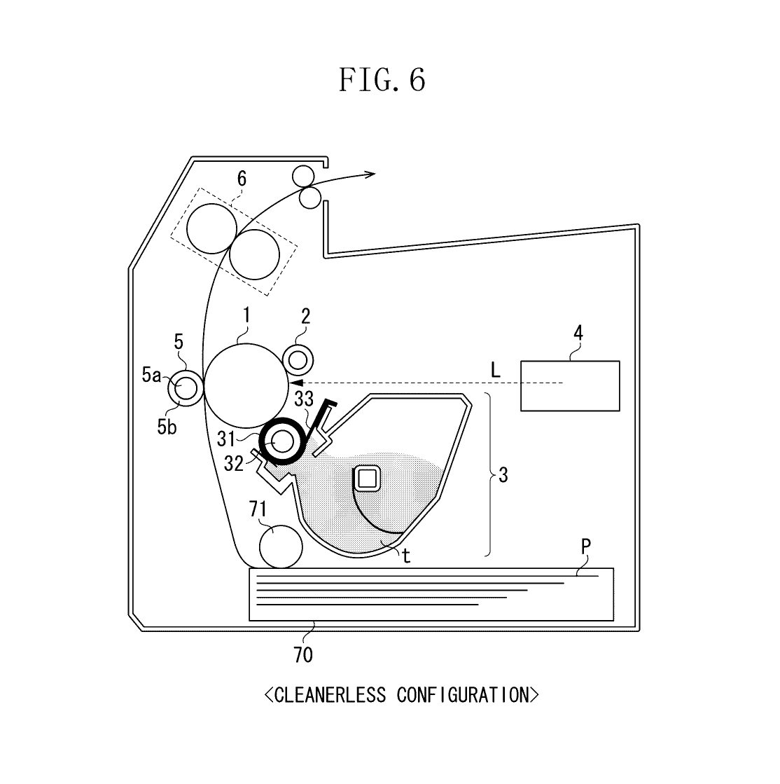

A cleanerless system according to the present exemplary embodiment will be described in more detail below with reference to FIG. 6. Residual transfer toner remaining on the photosensitive drum 1 after the transfer process is negatively charged, similar to the photosensitive drum 1, by electric discharge between the charging roller 2 and the photosensitive drum 1. At this timing, the surface of the photosensitive drum 1 is charged to −700 V. The negatively charged residual transfer toner does not adhere to but passes through the charging roller 2 because of a potential difference relation at the charging portion (a −700V surface potential on the photosensitive drum 1 and a −1300V potential on the charging roller 2).

The residual transfer toner that has passed the charging portion reaches a laser irradiation position where the surface of the photosensitive drum 1 is irradiated with laser light from a laser beam scanner 4. Since the amount of the residual transfer toner is not so large that the laser light of the laser beam scanner 4 is shielded, the residual transfer toner does not affect the image forming process for forming an electrostatic image (latent image) on the photosensitive drum 1. At the developing portion, the toner on a non-exposure portion (a surface of the photosensitive drum 1 not subjected to laser irradiation) out of the toner that has passed through the laser irradiation position is electrostatically collected by the developing sleeve 31. Then, such toner is further collected by the developing apparatus 3 via the developing sleeve 31.

On the other hand, the toner on an exposure portion (a surface of the photosensitive drum 1 subjected to laser irradiation) out of the toner that has passed through the laser irradiation position is not electrostatically collected and remains on the photosensitive drum 1 as it is. However, the toner may be partially collected by a physical force due to a circumferential speed difference between the developing sleeve 31 and the photosensitive drum 1. Such toner is also collected by the developing apparatus 4 via the developing sleeve 31.

Almost all of the residual transfer toner remaining on the photosensitive drum 1 is collected by the developing apparatus 3 except for the toner at the exposure portion. Then, the toner collected by the developing apparatus 3 is mixed with the toner stored in the developing apparatus 3 to be reused.

More specifically, the developing apparatus 3 develops a latent image and, at the same time, collects the toner remaining on the photosensitive drum 1.

The present exemplary embodiment employs the contact developing method for performing development by bringing the surface of the developing sleeve 31 into contact with the surface of the photosensitive drum 1. The surface of the developing sleeve 31 composed of a rubber layer contacts the photosensitive drum 1 by an inroad amount. Toner is efficiently collected from the photosensitive drum 1 by rotating the developing sleeve 31 in contact with the photosensitive drum 1 at a 140% circumferential speed.

In the present exemplary embodiment, the charging roller 2 is driven with a 110% circumferential speed difference relative to the photosensitive drum 1. A charging roller driving gear is configured to receive a driving force by engaging with a gear formed on a coupling member provided on the photosensitive drum 1.

By driving the charging roller 2 with a circumferential speed difference with respect to the photosensitive drum 1 in this way, through abrasion, sticking substances adhering to the charging roller 2 can be negatively charged at the portion contacting the photosensitive drum 1. Thus, the potential difference between the charging roller 2 and the photosensitive drum 1 returns the sticking substances to the photosensitive drum 1, reducing smudges on the surface of the charging roller 2.

### <Adverse Effect on Image Due to Foreign Substances>

In the cleanerless configuration, paper powder may be supplied from paper to the photosensitive drum 1 at the time of transfer. When collecting toner into the developing apparatus 3, paper powder is supplied from the photosensitive drum 1 to the developing sleeve 31 and therefore the foreign substances get contained also in the toner coat on the developing sleeve 31. When the number of printed sheets increases, the amount of paper powder in the developing sleeve 31 increases and the foreign substances are thrust into the nip portion between the developing sleeve 31 and the developing blade 33. The foreign substances may disturb the toner coat on the developing sleeve 31, possibly causing an adverse effect in a vertical stripe form on an image.

For the above-described reason, in the cleanerless configuration, an adverse effect in an image caused by the increase in the amount of foreign substances on the developing sleeve 31 prevents the prolongation of the life time (use period) of the cartridge.

### <Contact Configuration of Stirring Sheet and Developing Sleeve>

Similar to the first exemplary embodiment, in the present exemplary embodiment, the stirring sheet 34a and the developing sleeve 31 are brought into contact with each other with a stirring cycle in the forward direction, so that the foreign substances can be peeled off from the developing sleeve 31 to reduce the amount of sticking substances on the developing sleeve 31. Accordingly, an adverse effect on an image due to foreign substances is reduced, thus achieving the prolongation of the life time of the cartridge. Further, by using the contact developing method, the influence of vibration can be reduced when the stirring sheet 34a contacts the developer bearing member.

Conditions such as the diameter of the developing sleeve 31, the length, thickness, and material of the stirring sheet 34a, the distance between the developing sleeve 31 and the stirring sheet 34a, the moving speed of each member, etc. and the mechanism for peeling off foreign substances on the developing sleeve 31 according to the present exemplary embodiment are similar to those according to the first exemplary embodiment, therefore, redundant descriptions thereof will be omitted.

### <Miscellaneous>

While, in the above-described exemplary embodiments, there are no explicit descriptions about what are detachably attached to the main body of the image forming apparatus, there are various forms.

For example, referring to the first exemplary embodiment, the image bearing member, the charging member, the cleaning apparatus, and the developing apparatus may be integrally formed as a process cartridge which is detachably attached to the main body of the image forming apparatus. Instead of a process cartridge, a developing apparatus may be by itself detachably attached to the main body of the image forming apparatus. Further, when the developing apparatus is by itself detachably attached to the main body of the image forming apparatus, the image bearing member, the charging member, and the cleaning apparatus may be integrally formed as an image bearing member cartridge (drum cartridge). In this case, the developing apparatus and the image bearing member cartridge are configured to be detachably attached separately to the main body of the image forming apparatus.

The developing apparatus may be by itself detachably attached to the main body of the image forming apparatus, and the image bearing member may be fixed thereto.

As a matter of course, this configuration can be used not only in the first exemplary embodiment but also in the cleanerless configuration according to the second exemplary embodiment in a similar way.

Although, in the above-described exemplary embodiments, the stirring sheet 34a as a sheet member contacts the developing sleeve 31 as a developer bearing member, the configuration is not limited thereto. For example, the stirring sheet 34a may be a brush-like member or a comb-like member, instead of a sheet member. Providing certain hardness to the contact portion in contact with the developer bearing member enables peeling off the toner at the tip of the stirring sheet 34a. The stirring sheet 34a may be a sheet member with a slit or a cut at the tip.

The developer bearing member may be not only a hollow developing sleeve but also a developing roller.

As described above, efficiently removing sticking substances adhering to the developer bearing member enables prolonging the use period of the developing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-176063, filed Sep. 7, 2015, and No. 2016-154526, filed Aug. 5, 2016, which are hereby incorporated by reference herein in their entirety.

What is claimed is:

1. A developing apparatus comprising:
a developer bearing member configured to bear a developer and rotate to apply the developer to an image bearing member to perform image forming; and
a stirring member, having (1) a rotating rotary member and (2) a flexible sheet member attached to the rotary member, configured to stir a developer, a free end of the sheet member being capable of contacting a surface of the developer bearing member in an image forming region,
wherein the developer bearing member rotates in a first rotational direction,
wherein the stirring member rotates in a second rotational direction which is opposite to the first rotational direction, and
wherein, in a contact region where the stirring member and the development bearing member contact each other, a moving speed of the developer bearing member is higher than a moving speed of the stirring member.

2. The development apparatus according to claim 1, wherein, in a case where an amount of the developer is equal to or greater than a predetermined amount, the stirring member does not contact the developer bearing member, and
wherein, in a case where the amount of the developer is smaller than the predetermined amount, the stirring member contacts the developer bearing member.

3. The developing apparatus according to claim 1, wherein the stirring member contacts the developer bearing member in a second half of a life time of the developing apparatus.

4. The developing apparatus according to claim 1, wherein, when the stirring member and the developer bearing member contact each other, the sheet member bends and changes its shape so that an end surface at the free end of the stirring sheet is oriented in a direction opposite to the moving direction of the developer bearing member in the contact region.

5. The developing apparatus according to claim 1, wherein, after an image formed on the image bearing member is transferred onto a recording medium, the developer bearing member collects a developer remaining on the image bearing member.

6. The developing apparatus according to claim 1, wherein, in a position taken at the time of use, a bottom portion of a developer containing chamber for storing a developer is lower than a lowermost portion of the developer bearing member.

7. The developing apparatus according to claim 6, wherein the stirring member is disposed in the developer containing chamber, and
wherein the sheet member is configured to contact the bottom portion of the developer containing chamber.

8. The developing apparatus according to claim 7, further comprising:
a developing chamber where the developer bearing member is disposed,
wherein the developing chamber has an opening for receiving the developer from the developer containing chamber.

9. The developing apparatus according to claim 1, wherein a magnetic material is contained in the developer bearing member.

10. The developing apparatus according to claim 1, wherein the developer is a magnetic developer.

11. The developing apparatus according to claim 1, wherein the developer is a mono component developer.

12. The developing apparatus according to claim 1, wherein, when the stirring member is not rotating, the stirring member and the developer bearing member do not contact each other.

13. The developing apparatus according to claim 1, wherein the developing apparatus is configured to be detachably attached to a main body of an image forming apparatus, and
wherein the developing apparatus further comprises:
a driving force receiving portion configured to receive a driving force from the main body of the image forming apparatus; and
a driving force transfer portion configured to transmit the driving force received from the main body of the image forming apparatus by the driving force receiving portion, to the stirring member and the developer bearing member.

14. A developing apparatus comprising:
a developer bearing member configured to bear a developer, rotate to apply the developer to an image bearing member to perform image forming, and, after an image formed on the image bearing member is transferred onto a recording medium, collect a developer remaining on the image bearing member; and
a stirring member configured to rotate to stir the developer and, when rotating, contact a surface of the developer bearing member in an image forming region,
wherein the developer bearing member rotates in a first rotational direction,
wherein the stirring member rotates in a second rotational direction which is opposite to the first rotational direction, and
wherein, in a contact region where the stirring member and the development bearing member contact each other, a moving speed of the developer bearing member is higher than a moving speed of the stirring member.

15. A process cartridge comprising the image bearing member and the developing apparatus according to claim 1.

16. A process cartridge comprising the image bearing member and the developing apparatus according to claim 14.

17. The process cartridge according to claim 15, wherein the image forming is performed in a state where the image bearing member and the developer bearing member contact each other.

18. The process cartridge according to claim 16, wherein the image forming is performed in a state where the image bearing member and the developer bearing member contact each other.

19. An image forming apparatus configured to form an image on a recording medium, comprising the developing apparatus according to claim 1.

20. An image forming apparatus configured to form an image on a recording medium, comprising the developing apparatus according to claim 14.

21. An image forming apparatus configured to form an image on a recording medium, comprising the process cartridge according to claim 15.

22. An image forming apparatus configured to form an image on a recording medium, comprising the process cartridge according to claim 16.

23. An image forming apparatus comprising:
a developer bearing member configured to bear a developer and rotate to apply the developer to the image bearing member to perform image forming;
a stirring member, having (1) a rotating rotary member and (2) a flexible sheet member attached to the rotary member, configured to stir a developer, a free end of the sheet member being capable of contacting a surface of the developer bearing member in an image forming region; and
a control unit configured to perform control to rotate the developer bearing member in a first rotational direction, rotate the stirring member in a second rotational direction opposite to the first rotational direction, and, in a contact region where the stirring member and the development bearing member contact each other, make a moving speed of the developer bearing member higher than a moving speed of the stirring member.
